(19) United States
(12) Patent Application Publication
(10) Pub. No.: US 2012/0221448 A1
(43) Pub. Date: Aug. 30, 2012

(54) METHOD AND SYSTEM FOR DETECTING AND ADDRESSING INVOICING ANOMALIES

(75) Inventors: John Herman Evans, Encinitas, CA (US); Earl Bryan Beutler, Ecinitas, CA (US); Roger Jaccaud, Oceanside, CA (US)

(73) Assignee: Vision InfoSoft Corporation, Carlsbad, CA (US)

(21) Appl. No.: 13/034,289

(22) Filed: Feb. 24, 2011

(51) Int. Cl. G06Q 30/00

(52) U.S. Cl. 705/34

(57) ABSTRACT

Methods, systems and computer-readable medium for enabling an information technology system to detect pricing anomalies and present detected anomalous pricing to a human operator. A price value digitally stored in an electronic memory associated with a part number and included in an invoice process is compared with one or more price ranges. When the price value fall outside of at least one price range, the price value is provided to a human administrator for deletion, approval or modification, prior to the issuance of an invoice and wherein the human administrator may direct the computer, or a networked computer, to halt generating or transmitting the invoice or to generate a modified invoice. A modified invoice may be issued with one or more line items deleted and or modified as directed by the human administrator. The computer may additionally be configured to detect associations of part numbers with defined kits.

### FIELD OF THE INVENTION

The present invention relates generally to information technology systems and methods that are applied to, and configured for, managing business operations, and more particularly to information technology systems and methods for generating and documenting invoices.

### BACKGROUND OF THE INVENTION

The introduction of semi-automated and automating billing systems and procedures can superficially improve business process efficiencies while undetectably increasing the frequency of relationship-damaging errors in invoice processing and generation. The more obvious danger of under billing, i.e., charging a customer less than a delivered good or a supplied service is priced at, is compounded by the danger of souring a customer relationship by over billing or erratic billing. Few things shake confidence and damage trust in a commercial relationship more than inaccuracies in the prices actually charged and demanded for goods and services.

Yet the attraction to corporate management of automated or semi-automated billing typically increases as a growing firm is forced to manage an inventory of growing complexity, market larger quantities of part numbers and serve an expanding customer base. Engaging third party service providers to perform or support one or more aspects of an invoicing process introduces yet another dimension of risk factors into a corporate invoicing operation. The efficiency potentially gained in automating and/or out sourcing elements of an invoicing process is leading many firms to integrate these systems and external contractors into central areas of their internal business operations. Yet the prior art offers little in the way to evaluate, track or reduce the operational risk introduced by these rather common but often highly complex and unique integrations.

The information technology that enables more rapid generation of tracking payables by both part numbers and by customer identifiers also provides the capability to inject communication steps in an invoicing process wherein human judgment can be applied to correct, modify, direct and/or halt the generation of invoices prior to transmission to a payer. However, the prior art generally neglects the long felt need of many corporations and firms to optimally insure the integrity and accuracy of their invoicing practices.

Therefore, it would be advantageous to have an information technology system and method that (a.) detects possible inaccuracies in prices indicated within an automated or semi-automated invoice process prior to the transmission of an invoice derived from the indicated prices, and (b.) presents potentially inaccurate prices for review by a human administrator prior to the issuance of possibly inaccurate invoice.

### SUMMARY OF THE INVENTION

This and other objects of the present invention made obvious in light of this disclosure are addressed by the method of the present invention, wherein methods, systems and computer-readable media for detecting anomalous billing information and informing a human administrator of the detected anomalous billing information are provided. According to a first aspect of the method of the present invention, an information technology system is provided that examines prices of part numbers to be included in an invoicing process and examines the prices and part numbers to detect anomalous pricing. When anomalous pricing is detected, the invoicing process is halted and the possibly incorrect price and associated part number is provided to a human administrator, or “user”.

According to a second optional aspect of the invented method, the human administrator is empowered by means of information technology to (a.) cancel an issuance of an invoice; (b.) modify an invoice; (c.) delete a line item from an invoice; (d.) add a line item to an invoice; and/or (e.) issue an invoice or direct an invoice to be issued.

According to a third optional aspect of the invented method, anomalies are detected by an information technology system by comparing a price to a price range, wherein, the price range is derived from (a.) pricing data observed within a set time period; (b.) pricing data observed in invoices addressed to a same customer or set of customers; (c.) a history of prices of a part number associated with the price; (d.) pricing data observed in Internet traffic; (e.) pricing data read from executed transactions one or more additional customers; and/or (f.) pricing data provided by a third party, such as a wholesale or a retail price or prices suggested by a manufacturer or a distributor.

According to a fourth optional aspect of the invented method, the human administrator may transmit, or direct an information technology system to transmit, an invoice via (a.) an electronic communications network, such as the Internet, a telephony network, or a computer network; (b.) electronic facsimile transmission; and/or (c.) a postal service.

According a fifth optional aspect of the invented method, an information technology system generates and/or employs an electronic invoice record that includes data, such as a customer identifier and a plurality of part numbers with associated prices, wherein the information technology system derives and publishes an invoice from the electronic invoice record.

According a sixth optional aspect of the invented method, the information technology system is applied to detect when a plurality of part numbers of an electronic invoice record, or included in an invoice, are comprised within a same kit. The information technology system may (a.) inform the human administrator of the possibility of a kit purchase being intended; (b.) detect if one or more part numbers included in the same electronic invoice record, or included in a same invoice, are lacking in sufficient quantity to complete a kit or a selected quantity of kits; and/or (c.) detect if a part number may be incorrectly associated with or included in an intended kit order.

According a seventh optional aspect of the present invention, an information technology system is provided that may execute or instantiate one or more steps or aspects of the invented method. Alternatively or additionally, a computer-readable medium may be provided that includes machine executable instructions that direct an information technology system to execute or instantiate one or more steps or aspects of the invented method.

It is understood that other embodiments of the present disclosures will become readily apparent to those skilled in the art from the following detailed description, wherein it is shown and described only exemplary embodiments of the present disclosures by way of illustration. As will be realized, the teachings herein are capable of other and different embodiments and its several details are capable of modification in various other respects, all without departing from the spirit and scope of the present disclosures. Accordingly, the drawings and detailed description are to be regarded as illustrative in nature and not as restrictive.

### INCORPORATION BY REFERENCE

All publications mentioned herein are incorporated herein by reference to disclose and describe the methods and/or materials in connection with which the publications are cited. All publications, patents, and patent applications mentioned in this specification are herein incorporated by reference in their entirety and for all purposes to the same extent as if each individual publication, patent, or patent application was specifically and individually indicated to be incorporated by reference.

Such incorporations include U.S. Pat. No. 6,058,380 (inventors Anderson, et al.; issued on May 2, 2000) titled “System and method for electronically processing invoice information”; U.S. Pat. No. 6,826,542 (inventors Virgin, et al.; issued on Nov. 30, 2004) titled “System and method for collecting, enhancing and distributing invoices electronically via the internet”; U.S. Pat. No. 6,882,986 (inventors Heinemann, et al.; issued on Apr. 19, 2005) titled “Method for automatic processing of invoices “; U.S. Pat. No. 7,389,286 (inventors Holmes, et al.; issued on Jun. 17, 2008) titled “Enhanced trade compliance system: audit processing, payment balancing process and amendment processing”; U.S. Pat. No. 7,478,061 (inventors Spreng, et al.; issued on Jan. 13, 2009) titled “Automated audit process”; U.S. Pat. No. 7,685,076 (inventors Moore, et al.; issued on Mar. 23, 2010) titled “Online reduction in repair and maintenance costs”; US Patent Application Publication No. 20080249936 (inventors Miller, et al.; published on Oct. 9, 2008) titled “Bill paying systems and associated methods”); US Patent Application Publication No. 20080133388 (inventors Alekseev, et al.; published on Jun. 5, 2008) titled “Invoice exception management”; and US Patent Application Publication No. 20080270273 (inventors Koltunov, et al.; issued on Oct. 30, 2008) titled “Method and system for real-time invoice validation and reconciliation”.

The publications discussed or mentioned herein are provided solely for their disclosure prior to the filing date of the present application. Nothing herein is to be construed as an admission that the present invention is not entitled to antedate such publication by virtue of prior invention. Furthermore, the dates of publication provided herein may differ from the actual publication dates which may need to be independently confirmed.

### BRIEF DESCRIPTION OF THE FIGURES

These, and further features of various aspects of the present invention, may be better understood with reference to the accompanying specification, wherein:

FIG. 1 is a schematic of an electronic communications network that includes a client system, an invoicing system, a purchasing system, a telephony system and the Internet;

FIG. 2 is a schematic diagram of a computer that may be, or be comprised within, the client system, the invoicing system, or the purchasing system of FIG. 1;

FIG. 3 is a process diagram of a first plurality of aspects of the method of the present invention, or invented method, that may be practiced by user interaction with the electronic communications network of FIG. 1;

FIG. 4 is a flow chart of a second plurality of the invented method that may be practiced by user interaction with the electronic communications network of FIG. 1;

FIG. 5 is a flow chart of a third plurality of aspects of the invented method that may be practiced by user interaction with the electronic communications network of FIG. 1;

FIG. 6 is a process diagram of a fourth plurality of aspects of the invented method wherein the part numbers of an invoice data is compared against a plurality of kit records and a user is informed of possible discrepancies;

FIG. 7 is a representation of an exemplary invoice record that may be stored within a database of the network of FIG. 1 and/or computer and/or media of FIG. 2;

FIG. 8 is a representation of an exemplary customer record that may be stored within a database of the network of FIG. 1 and/or computer and/or media of FIG. 2;

FIG. 9 is a representation of an exemplary part number record that may be stored within a database of the network of FIG. 1 and/or computer and/or media of FIG. 2;

FIG. 10 is a representation of an exemplary price record that may be stored within a database of the network of FIG. 1 and/or computer and/or media of FIG. 2;

FIG. 11 is a representation of an exemplary kit record that may be stored within a database of the network of FIG. 1 and/or computer and/or media of FIG. 2;

FIG. 12 is a representation of an exemplary part number equivalency record that may be stored within a database of the network of FIG. 1 and/or computer and/or media of FIG. 2;

FIG. 13 is a representation of an exemplary first price record that may be stored within a database of the network of FIG. 1 and/or computer and/or media of FIG. 2;

FIG. 14 is a representation of an exemplary first price range record that includes a price range record identifier, a first part number identifier, a low unit price value and a high unit price value VH, and a time date stamp;

FIG. 15 is an exemplary cost record that includes a cost record identifier , a part number, a unit price, a part cost, and a costing time date marker; and

FIG. 16 is a process diagram of a fifth plurality of aspects of the invented method wherein a price for a part number is referenced with a cost increase of that part number to help insure that the price to be issued for the part number is up to date.

### DETAILED DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

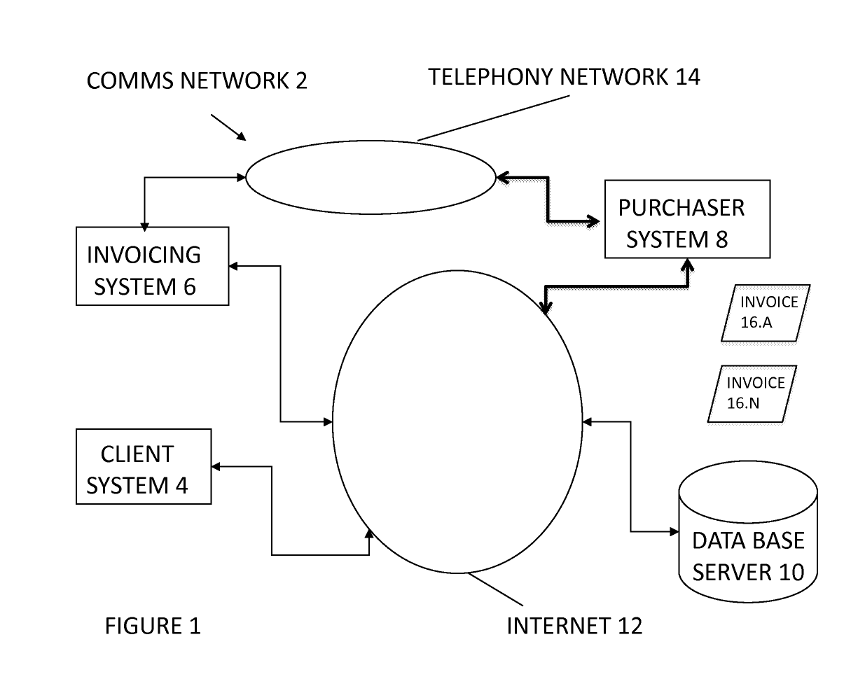

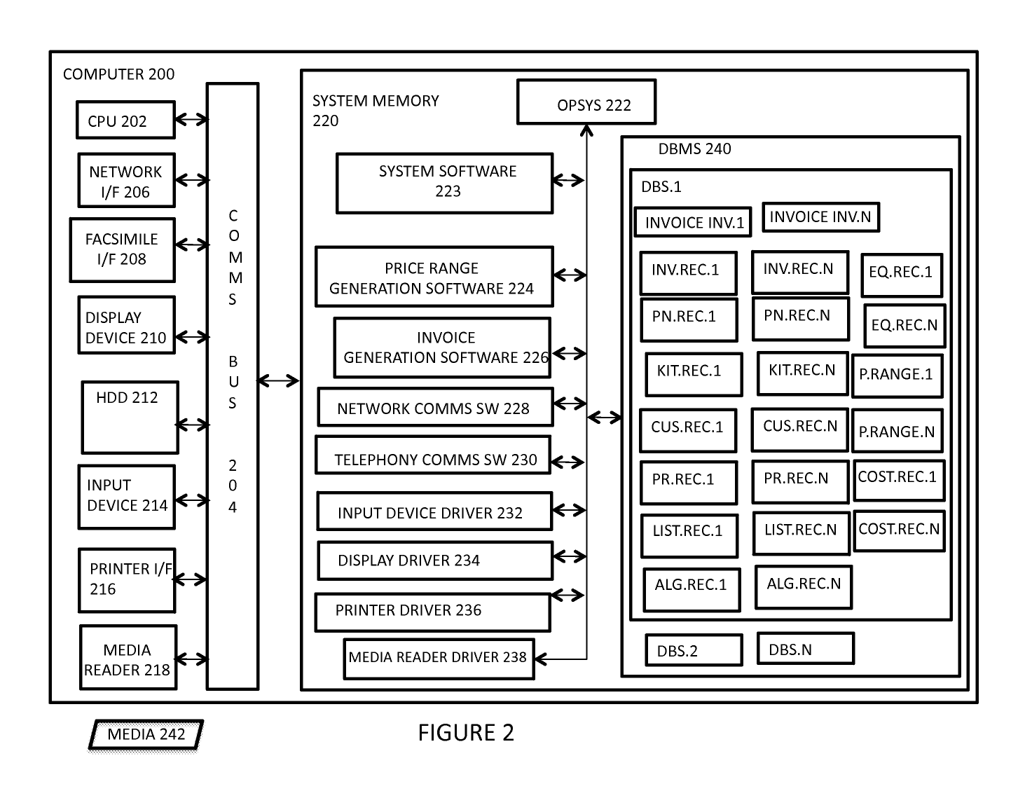

Referring generally to the Figures and particularly to FIG. 1, an electronic communications network 2 includes a client system 4, an invoicing system 6, a purchaser system 8 and a database server 10 are bi-directionally communicatively coupled via the Internet 12 and/or a telephony system 14. The client system 4 sends invoicing data and instructions to the invoicing system 6, whereupon the invoicing system 6 generates invoice documents, in electronic form IN.1-IN.N or optionally as hard copy invoices 16.A-16.N. The electronic invoices INV.N-INV.N may be transmitted to the purchaser system 8 via the Internet 12 or by facsimile transmission via the telephony system 14. Alternatively or additionally the invoicing system 6 may be configured to print the hard copy invoice 16.A-16.N. One or more hard copy invoice 16.A-16.N may be addressed and suitable for mailing via a postal service, such as the United States Post Office, Federal Express™ delivery service, or United Parcel Service™ delivery service, or other suitable delivery service known in the art. The database server 10 and the invoicing system 6 each comprise electronic memories 220 (see FIG. 2) that maintain databases DB.1-DB.N containing electronic records of customers, part numbers, list prices, price ranges, previously issued electronic invoice records INV.1-INV.N and/or algorithms and software for generating price ranges.

Referring now generally to the Figures and particularly to FIG. 2, FIG. 2 is a schematic diagram of a computer 200 that serves as, or is comprised within, the client system 4, the invoicing system 6, the purchaser system 8 and the database server 10. The computer 200 includes a central processing unit 202 (hereinafter “CPU”) that is bi-directionally communicatively coupled by an internal communications bus 204 with a network interface circuit 206, a facsimile transmission interface circuit 208, a display device 210, a hard disk drive 212 a user input device 214, a printer interface circuit 216, a media reader module 218 and the system memory 220.

The computer 200 may be or comprise (a.) a network-communications enabled SUN SPARCSERVER™ computer workstation marketed by Sun Microsystems of Santa Clara, Calif. running a UBUNTU™ operating system available from Canonical Group Limited, having offices at 27th Floor, Milbank Tower 21-24 Milbank London SW1P 4PQ United Kingdom, a LINUX™ operating system as provided by Red Hat< inc. of Raleigh, N.C., or a UNIX™ operating system as published by AT&T Corporation of Dallas, Tex.; (b.) a network-communications enabled personal computer configured for running WINDOWS XP™, VISTA™ or WINDOWS 7™ operating system marketed by Microsoft Corporation of Redmond, Wash.; (c.) a VAIO FS8900™ notebook computer marketed by Sony Corporation of America, of New York City, N.Y.; (d.) a PowerBook G4™ personal computer as marketed by Apple, Inc. of Cupertino, Calif.; and/or a suitable mobile communications device known in the art, such as an iPhone G4™ as marketed by Apple, Inc. of Cupertino, Calif.

The system memory 200 loads and stores a software operating system “OPSYS” 222, such as a LINUX™ or UNIX™ operating system; a WINDOWS XP™, VISTA™ or WINDOWS 7™ operating system as marketed by Microsoft Corporation of Redmond, Wash.; or a MAC OS X operating system as marketed by Apple, Inc. of Cupertino, Calif. The system memory 220 further loads and stores a system software 223, a price range generation software program 224, a network communications software program 226, a network communications software 230, a telephony communications software 230, an input device driver 232, a display device driver 234, a printer driver 236, a media driver 238 and a data base management system 240. The database management system DBMS 240 may be or comprise and an object oriented database management system (“OODBMS”) and/or a relational database management system (“RDBMS”), and one or more databases DBS.1-DBS.N. A first database DBS.1 and/or one or more additional databases DBS.2-DBS.N may be or comprise an object-oriented database and/or a relational database.

The first database DBS.1 stores a plurality of records and record types, to include records of previously issued invoices INV.1-INV.N, electronic invoice data records INV.REC.1-INV.REC.N, part number records PN.REC.1-PN.REC.N, kit records KIT.REC.1-KIT.REC.N, customer pricing records CUS.REC.1-CUS.REC.N, price range records P.RANGE-P.RANGE.N, price list records PR.REC.1-PR.REC.N, pricing algorithm records ALG.REC.1-ALG.REC.N, cost records COS.REC.1-COS.REC.N, part equivalency records EQ.REC.1-EQ.N, price list records LIST.REC.1-LIST.REC.N, and price records PR.1-PR.N.

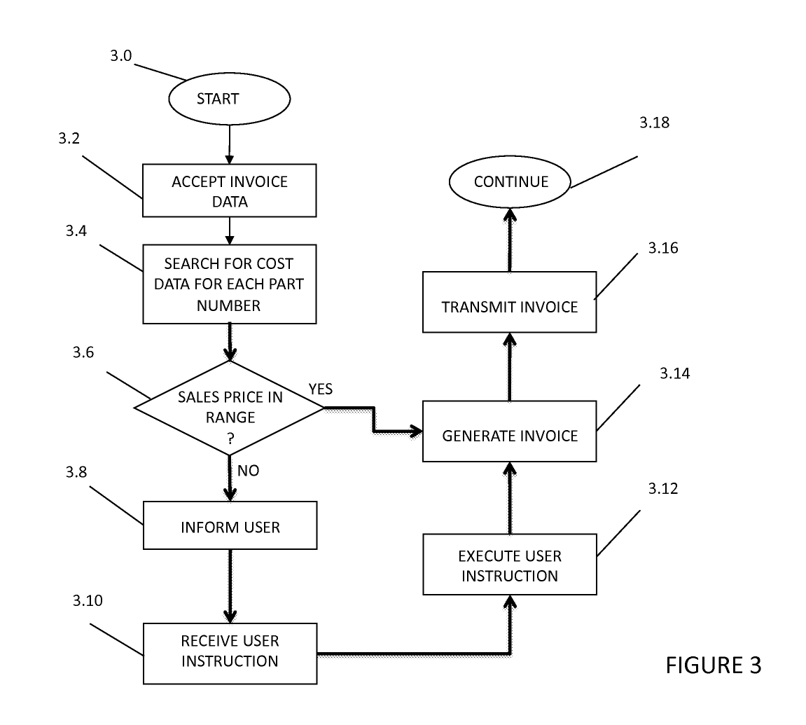

The system software 223 includes machine-readable software encoded instructions that direct the computer 200 to create, store, instantiate and/or execute one, a plurality, or all of the records, process steps, and process disclosed in FIGS. 3 through 16.

An electronic media 242 and the media reader 218 are selected and configured to enable the media reader 218 to access software encoded information and instructions from the media reader 218 and for transmission through the communications bus 204 to the CPU 202, the electronic memory 220, and other elements of the computer 200. The electronic media 242 may store a plurality of records and record types, to include records of previously issued invoices, electronic invoice data records INV.1-INV.N, part number records, kit records, customer records, price range records, price list records and pricing algorithm records.

It is understood that one or more records or information stored within the first database DBS.1 may be stored as originals or copies in the media 242 or elsewhere within the network 2.

Referring now generally to the Figures and particularly to FIG. 3, FIG. 3 illustrates a first process of the invoicing system 6 wherein the invoicing system 6 receives invoicing data from the client system 4 in step 3.0. The invoicing data includes a customer identifier CUSTOMER.ID, one or more part numbers PN.1-PN.N with associated quantities, and unit prices for each part number PN.1/PN.N. In step 3.4 the invoicing system 6 generates and electronic invoice record INV.REC.1-INV.REC.N and populates the electronic invoice record INV.REC.1-INV.REC.N with the invoicing data received in step 3.2. The invoicing system 6 determines in step 3.6 if any unit price included in the invoicing data is outside of its associated price range. The price range of each part number PN.1-PN.N of step 3.6 may be generated by statistical analysis of a selected set recorded prices associated with each part number PN.1-PN.N. One or more algorithms used by the invoicing system 6 to generate price ranges may be made recorded in, and available from, and algorithm record ALG.REC.1-ALG.REC.N as stored in a database DBS.1-DBS.N and/or electronic storage media. Price ranges may be stored in price range records P.RANGE.1-P.RANGE.N that are each individually associated with a part number PN.1-PN.N

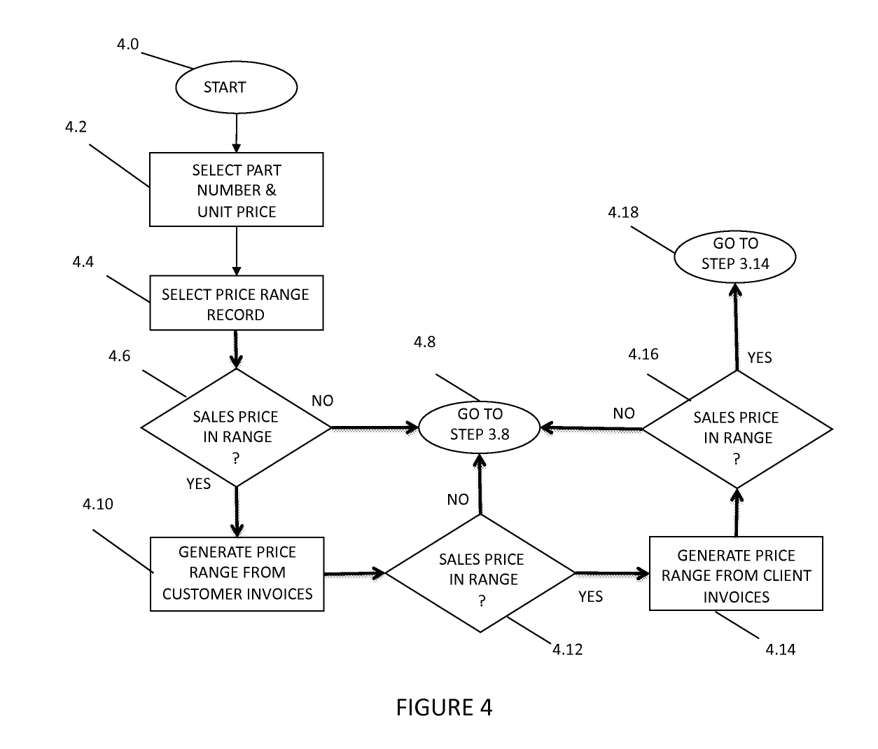

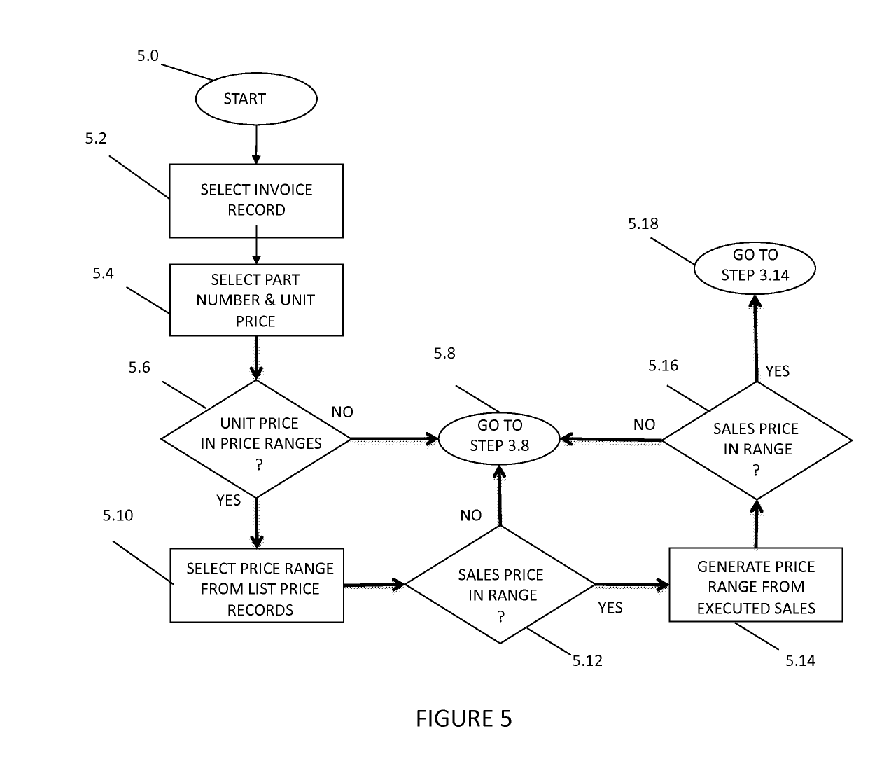

In one prior art technique, a price range for an exemplary first part number PN.1 may be generated by selecting preferably eight or more recorded prices of sale or offer for sale of a same first part number PN.1. The eight or more recorded prices related to the first part number PN.1 are used to compute a mean (\tilde{X}) and a standard deviation (S). An acceptable price range is then set as being a range plus or minus from the mean \tilde{X}. For example, an expected price range may be defined within a value range defined between a low value VL stored in an exemplary first price range record P.RANGE.1 and set at a value of \tilde{X}−(kS). The high value VH of the same exemplary price range record P.RANGE.1 may be set equal to the sum of \tilde{X}+(kS) In other words, the higher value VH set equal to \tilde{X}+(kS) and the lower value VL set equal to \tilde{X}−(kS) may then be stored in the exemplary first price range record P.RANGE.1 be associated be the invoicing system 6 and the network 2 with the exemplary first part number PN.1, particularly as applied in (a.) step 3.6 of the method of FIG. 3, (b.) 4.6 of the method of FIG. 4, and (c.) step 5.6 of the method of FIG. 5.

A value of 2.5 may be applied in the typical value for constant k. A price associated with the first part number PN.1 in an invoice record INV.REC.1-INV.REC.N may be compared with the expected price range in step 3.6. Where the listed unit price PR.1 of an exemplary first invoice INV.REC.1 falls outside of the acceptable price range, i.e., outside of the stored value range defined by the calculated value of \tilde{X}−(kS) and the lower value \tilde{X}+(kS) the invoicing system proceeds from step 3.6 to step 3.8. Where the listed unit price PR.1 of an exemplary first invoice INV.REC.1 falls within of the acceptable price range, the invoicing system proceeds from step 3.6 to step 3.14.

By illustration, consider a price range that is calculated for a first part number PN.1 wherein the first part number PN.1 is associated with price values 46, 48, 38, 45, 47, 44, 45, 43, and 44. These price values, as associated with the first part number PN.1. may be harvested from, one or more invoices INV.1-INV.N, invoice records INV.REC.1-INV.REC.N, price records PR.REC.1-PR.REC.N, part number records PN.REC.1-PN.REC.N, price list records LIST.REC.1-LIST.REC.N, and/or customer records CUS.REC.1-CUS.REC.N. Further consider that a new invoice record INV.REC.1 is being generated by the method of FIG. 3, 4 or 5, and that a price value of 58 is associated with the first part number in this process. The mean value and the variance of the nine harvested prices are respectively 44.444, and 2.877. Where k is set at 2.5, the high value VH of the first price range record P.RANGE.1 would recorded at 51.637 and the low value VL of the first price range record P.RANGE.1 would recorded as 37.25. The time date stamp TDS.1 of the first price range record would record the time and date that the high value HL and low value VL were generated, or optionally, last entered, validated or confirmed. The first price range record P.RANGE.1 may then be accessed by the invoicing system 6, the client system 4, and/or the data base server 10 in 3.6 (or as included in the method of FIG. 4 in step 4.4, step 4.10, and/or step 4.14, and/or as included in the method of FIG. 5 in steps 5.6, 5.10, and/or 5.14) to compare against a newly considered price for the first part number PN.1, as in the method of the present invention, and as instantiated in (a.) step 3.6 of the method of FIG. 3, (b.) step 4.6 or step 4.12 of the method of FIG. 4, and (c.) step 5.6 of the method of FIG. 5. Alternately, a price range may be generated, and a low value LV and a high value VL may be set, for each part number PN.1-PN.N in steps 3.6, 4.4, 4.6, 4.10, 4.12, 4.14, 4.16, 5.6, 5.10, 5.12, 5.14 and/or 5.16, rather than being read from a price range record P.RANGE.1-P.RANGE.N.

When the invoicing system 6 determines in step 3.6 that a unit price of a part number PN.1-PN.N is outside of an associated price range (as read from a price range record P.RANGE.1-P.RANGE.N associated with the part number PN.1-PN.N, or generated in an optional aspect of step 5.6), the invoicing system 6 proceeds to step 3.8 and to inform a user, or system administrator, of the invoicing system 6 and/or the client system 4, of the pricing anomaly.

Referring now to step 3.12, the invoicing system 6 receives a user instruction from either the client system 4, the invoicing system 6, or via the Internet 12 in step 3.10 and executes the user instruction. The user instruction may direct the invoicing system 6 to (a.) halt processing or generating an invoice from the electronic invoice record; (b.) modify a unit price; or (c.) generate an invoice that does not include any part number having an anomalous unit price designated in the invoicing data as received in step 3.2.

The invoice record INV.REC.1-INV.REC.N may alternatively or additionally be generated as an electronic invoice INV.1-INV.N and/or as a hard copy rendered from an invoice record INV.REC.1-INV.REC.N or an electronic invoice INV.1-INV.N and printed out in step 3.18. The invoice generated in step 3.16 is transmitted to the client system 6 in step 3.16 by electronic transmission via the Internet 12, by facsimile transmission via a telephony network to the purchasing system and/or by mailing of a hard copy invoice, with assistance by the user, to a customer address designated by the client system 4. The invoicing system 6 returns to alternate computational operations in step 3.18.

Referring now generally to the Figures and particularly to FIG. 4, a process of the invoicing system 6 that is in accordance with other aspects of the invented method is illustrated, wherein the invoicing system 6 selects a part number PN.1-PN.N and an associated unit price from a selected invoice record INV.REC.1-INV.REC.N in step 4.2, wherein the selected invoice record INV.REC.1-INV.REC.N specifies an exemplary customer identifier CUSTOMER.ID. In optional step 4.4 a price range record P.RANGE.1-P.RANGE.N AND having a high value VH and a low value VL associated with the same part number PN.1-PN.N selected in step 4.2 is selected. The invoicing system 6 in step 4.6 accepts the high value VH and the low value VL read in optional step 4.4, or alternatively generates a high value VH and a low value VL using an algorithm from an algorithm record ALG.REC.1-ALG.REC.N and harvesting pricing data associated with same part number PN.1-PN.N of step 4.2, wherein the pricing data may be read from one or more invoices INV.1-INV.N, invoice records INV.REC.1-INV.REC.N, price records PR.REC.1-PR.REC.N, part number records PN.REC.1-PN.REC.N, and/or price list records LIST.REC.1-LIST.REC.N. Where the unit price assigned to the selected part number PN.1-PN.N is determined in step 4.6 to fall outside of the price range of the price range record P.RANGE.1-P.RANGE.N selected in step 4.4, or alternatively, within the high value VH and the low value VL generated in step 4.6, the invoicing system 6 proceeds to step 4.8, whereupon the invoicing system 6 returns to step 3.8 and reports the anomalous pricing finding to one or more users via the client system 4 and/or the invoicing system 6.

Alternatively, when the invoicing system 6 determines in step 4.6 that the unit price of step 4.2 falls within the price range selected in step 4.4, the invoicing system 6 proceeds to step 4.10 and generates a customer history price range having a high value VH and a low value VL as statistically derived from a plurality of invoices INV.REC.1-INV.REC.N and/or customer history records CUS.REC.N-CUS.REC.N associated with the same customer identifier CUSTOMER.ID of step 4.2, and wherein the same part number PN.1-PN.N is listed and priced. One or more of the plurality of invoices INV.REC.1-INV.REC.N and/or customer history records CUS.REC.N-CUS.REC.N used to generate the customer history price range comprising a high value VH and a low value VL may be stored in the system memory 18 of the invoicing system 6, or accessible to the invoicing system 6 from elsewhere in the Internet 12 and/or from the electronic media in a price range record P.RANGE.1-P.RANGE.N.

The unit price of step 4.2 is then compared in step 4.12 with the customer history price range of step 4.10 as defined by the high value VH and the low value VL generated or accessed in step 4.10. When the invoicing system 6 determines in step 4.12 that the unit price assigned to the part number PN.1-PN.N of the invoice record INV.REC.1-INV.REC.N of step 4.2 falls outside of the customer history price range generated in step 4.10, the invoicing system 6 proceeds on to execute step 4.8, whereupon the invoicing system 6 returns to step 3.8 and reports the anomalous pricing finding to one or more users.

Alternatively, when the invoicing system 6 determines in step 4.12 that the unit price of step 4.2 falls within the customer history price range generated in step 4.10 from the customer records CUS.REC.1-CUS.REC.N that reference the same customer associated with the customer identifier CUSTOMER.ID of step 4.2, the invoicing system 6 proceeds from step 4.12 to step 4.14 and generates an industry price range derived from a plurality of invoices INV.REC.1-INV.REC.N and electronic records of price lists LIST.REC.1-LIST.REC.N generated by other sources than the client associated with the electronic invoice record INV.REC.1-INV.REC.N and wherein the same part number PN.1-PN and electronic records of price lists LIST.REC.1-LIST.REC.N used to generate the industry price range of step 4.14 may be stored in the system memory 18 of the invoicing system 6, or accessible to the invoicing system 6 from elsewhere in the Internet 12 and/or from the electronic storage media.

The unit price of step 4.2 is then compared in step 4.16 with the industry price range of step 4.10, wherein when the invoicing system 6 determines that the unit price assigned to the part number in the invoice record INV.REC.1-INV.REC.N falls outside of the industry price range generated in step 4.14, the invoicing system 6 proceeds on to execute step 4.8, whereupon the invoicing system 6 returns to step 3.8 and reports the anomalous pricing finding to one or more users.

Alternatively, when the invoicing system 6 determines in step 4.16 that the unit price of step 4.2 falls within the industry price range generated in step 4.14, the invoicing system 6 proceeds from step 4.16 to step 4.18 and returns to execute step 3.14 of the process of FIG. 3.

Referring now generally to the Figures and particularly to FIG. 5, a process of the invoicing system 6 that is in accordance with still other aspects of the invented method, wherein the invoicing system 6 selects an electronic invoice record INV.REC.1-INV.REC.N in step 5.2 and a part number PN.1-PN.N and an associated unit price from the selected electronic invoice record INV.REC.1-INV.REC.N in step 5.4. The invoicing system 6 may optionally proceed onto step 5.6 wherein one or more of the steps of the method of FIG. 4 may be executed, and proceeds on to step 5.8 in accordance with the method of FIG. 4, whereupon the invoicing system 6 returns to step 3.8 and reports the anomalous pricing finding to one or more users via the client system 4 and/or the invoicing system 6.

Alternatively, when the invoicing system 6 determines in step 5.6 that the unit price of step 5.2 falls within the price ranges selected or generated in step 5.6, the invoicing system 6 proceeds to step 5.10 and selects a list price range derived from a list price record LIST.REC.1-LIST.REC.N stored in the system memory 18 of the invoicing system 6, or accessible to the invoicing system 6 from elsewhere in the Internet 12 or from the electronic media.

The unit price of step 5.2 is then compared in step 5.12 with the list price range of step 5.10, wherein the invoicing system 6 determines whether the unit price indicated for the part number in the invoice record falls outside of the list price range generated in step 5.10. When the invoicing system 6 determines that the unit price falls outside of the list price range of step 5.10, the invoicing system 6 proceeds on to execute step 5.8, whereupon the invoicing system 6 returns to step 3.8 and reports the anomalous pricing finding to one or more users.

Alternatively, when the invoicing system 6 determines in step 5.12 that the unit price of step 5.2 falls within the list price range selected in step 5.10, the invoicing system 6 proceeds from step 5.12 to step 5.14 and generates a sales history price range derived from a plurality of electronic sales transaction records generated by other sources than the client associated with the electronic invoice record INV.REC.1-INV.REC.N, and stored in the system memory 18 of the invoicing system 6, or accessible to the invoicing system 6 from elsewhere in the Internet 12 or from the electronic storage media, wherein the same part number is listed. The unit price of step 5.2 is then compared in step 5.16 with the sales history price range of step 5.14, wherein when the invoicing system 6 determines that the unit price assigned to the part number PN.1-PN.N in the invoice record INV.REC.1-INV.REC.N falls outside of the sales history price range generated in step 5.14, the invoicing system 6 proceeds on to execute step 5.8, whereupon the invoicing system 6 returns to step 3.8 and reports the anomalous pricing finding to one or more users.

Alternatively, when the invoicing system 6 determines in step 5.16 that the unit price of step 5.2 falls within the sales history price range generated in step 5.14, the invoicing system 6 proceeds from step 5.16 to step 5.18 and returns to execute step 3.14 of the process of FIG. 3.

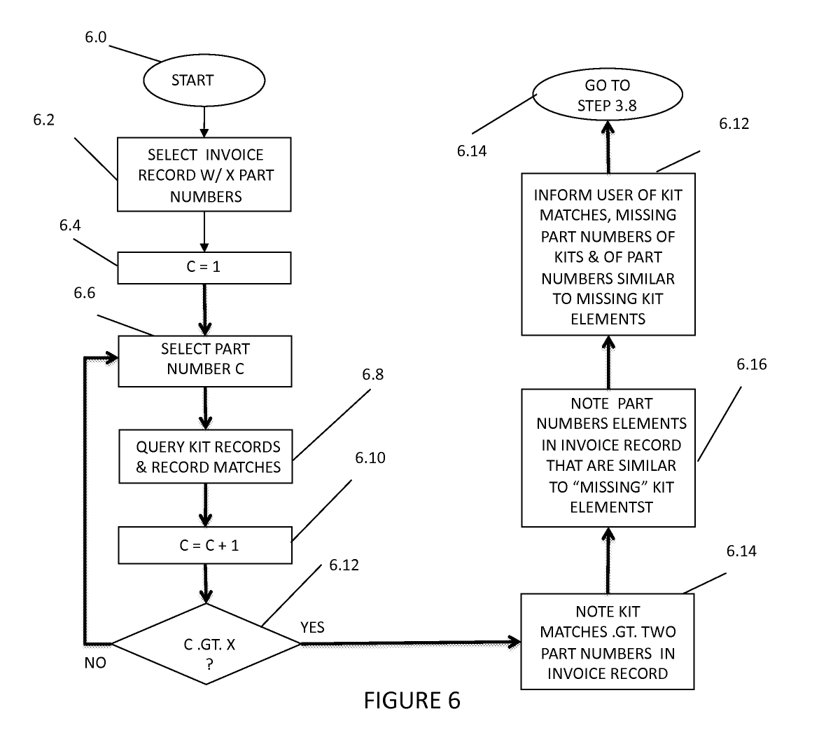

Referring now generally to the Figures and particularly to FIG. 6, FIG. 6 illustrates still other aspects of the invented method that may be performed or instantiated to determine whether a customer's purchase should be related to a kit that is defined to include a pre-established collection of part numbers. An electronic invoice record INV.REC.1-INV.REC.N, or alternatively a set of invoicing data, that specifies X quantity of unique part numbers is selected in step 6.2 and a counter C is set an initial value of a first part number PN.1 in a sequence of part numbers ordered from the initial value, e.g., a one value. A first part number PN.1 is selected in a first execution of step 6.6, and that selected part number PN.1 is compared against the plurality of kit records KIT.REC.1-KIT.REC.N, wherein a match between a kit record KIT.REC.1-KIT.REC.N as including the instant part number PN.1-PN.N is recorded. Each and every part number PN.1-PN.N of the X number of part numbers of the electronic invoice INV.REC.1-INV.REC.N, or invoicing data, of step 6.2 is examined is successive iterations of the loop formed by steps 6.6 through 6.12. When each of the X number of part numbers has been examined for matches with each and every kit record INV.REC.1-INV.REC.N, and these matches recorded by the invoicing system 6 in possibly multiple instances of step 6.8, the invoicing system 6 then proceeds to step 6.14 and reviews all found matches between part numbers PN.1-PN.N and kit records KIT.REC.1-KIT.REC.N and notes each kit record KIT.REC.1-KIT.REC.N that presents matches with two or more part numbers PN.1-PN.N of the relevant electronic invoice INV.REC.1-INV.REC.N, or invoicing data. The invoicing system 6 further examines the selected invoicing data, or electronic invoice record INV.REC.1-INV.REC.N in step 6.16 to identify any part numbers included therein that are similar in function to part numbers PN.1-PN.N that are included in a matched kit record KIT.REC.1-KIT.REC.N as noted in step 6.14 but are not included in the electronic invoice record INV.REC.1-INV.REC.N or invoicing data. The invoicing system 6 then reports to the invoicing system 6 and/or the client system 4 (a.) kit matches, (b.) missing kit elements PN.1-PN.N, and (c.) part numbers PN.1-PN.N presented in the invoicing data, or electronic invoice record.

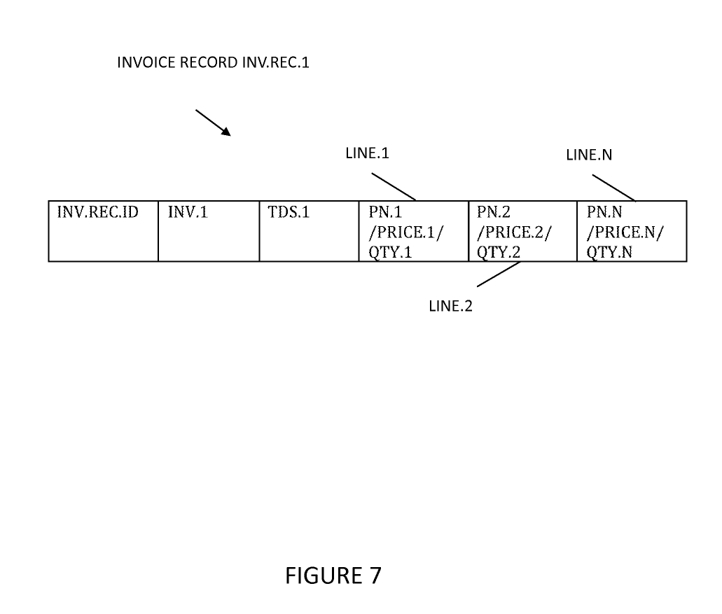

Referring now generally to the Figures and particularly to FIG. 7, FIG. 7 is a representation of an exemplary invoice record INV.REC.1 that includes an invoice record identifier INV.REC.ID, an invoice identifier INV.1, an time date stamp TDS.1, and a plurality of line item ENTRIES LINE.1-LINE.N, each line item entry including a part number PN.1-PN.N, a unit price PRICE.1-PRICE.N, and a quantity QTY.1-QTY.N of price numbers specified for the relevant line item.

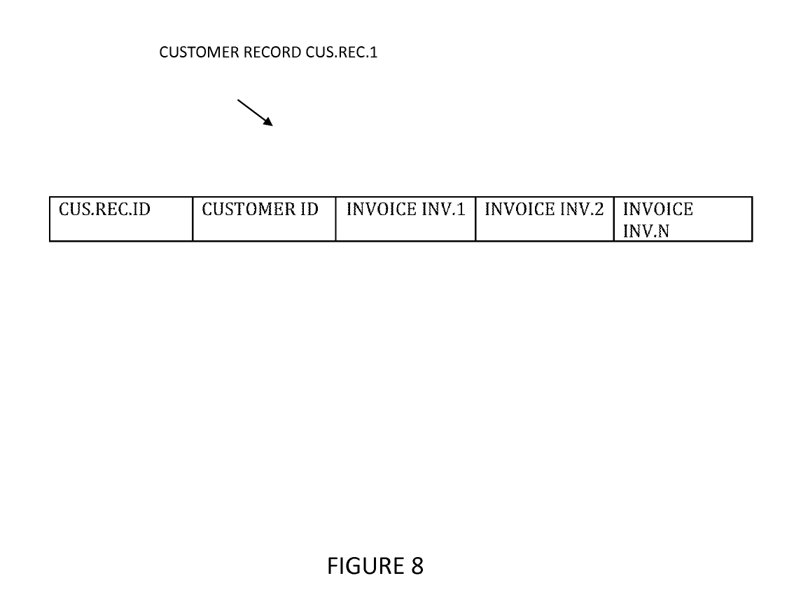

Referring now generally to the Figures and particularly to FIG. 8, FIG. 8 is a representation of an exemplary customer record CUS.REC.1 that includes a customer record identifier CUS.REC.ID, a customer identifier CUSTOMER.ID, and a plurality of invoice references INV.1-INV.N associated with customer identified by the customer identifier.

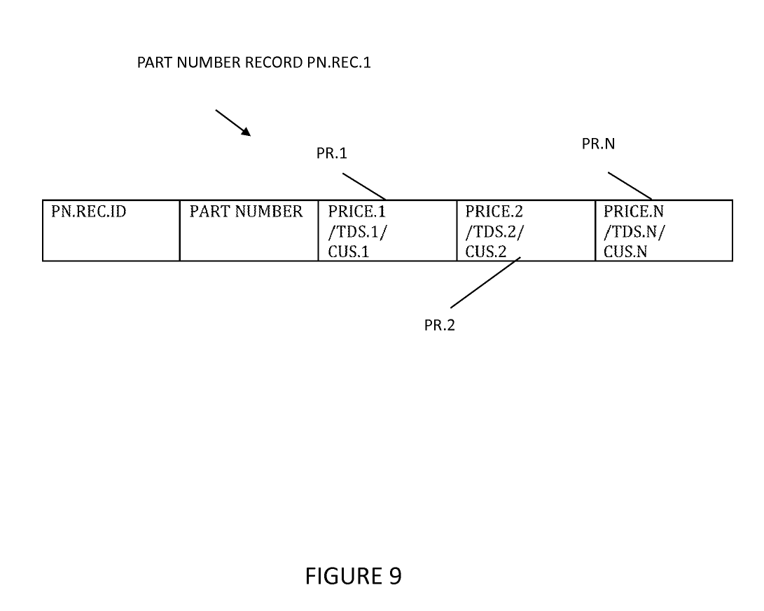

Referring now generally to the Figures and particularly to FIG. 9, FIG. 9 is a representation of an exemplary part number record PN.REC.1 that includes a part number record identifier PN.REC.ID, and a plurality of price instance entries PR.1-PR.N. Each price instance entry PR.1-PR.N specifies a unit price PRICE.1-PRICE.N, a time date stamp TDS.1-TDS.N, and an identifier of the customer CUS.1-CUS.N to whom the price PRICE.1-PRICE.N of the same price instance entry PR.1-PR.N was offered.

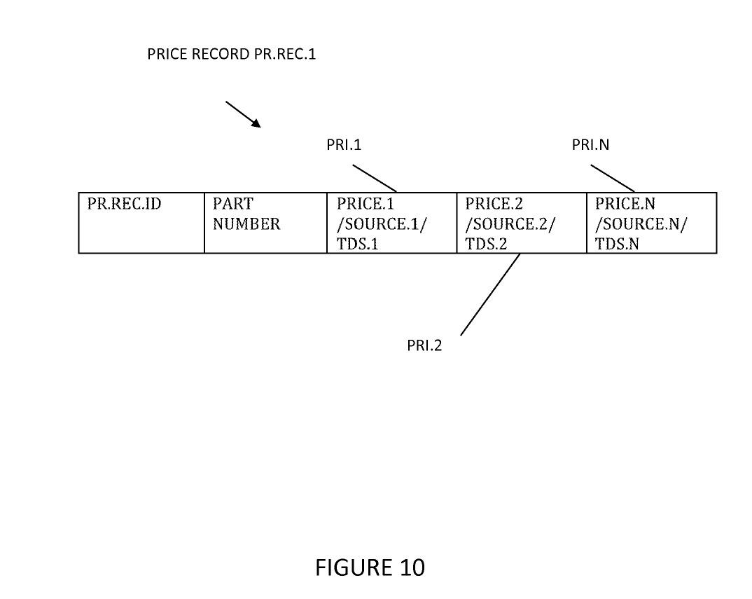

Referring now generally to the Figures and particularly to FIG. 10, FIG. 10 is a representation of an exemplary price record PR.REC.1 that includes a price record identifier PR.REC.ID, an associated part number, and a plurality of price instances PRI.1-PRI.N of previously offered prices for sale of the associated the part number. Each price record specifies a unit price PRICE.1-PRICE.N, a time date stamp TDS.1-TDS.N, and an identifier of an associated source, e.g. a manufacturer or a distributor, from which the unit price PRICE.1-PRICE.N of the same price instance PRI.1-PRI.N was received or originated.

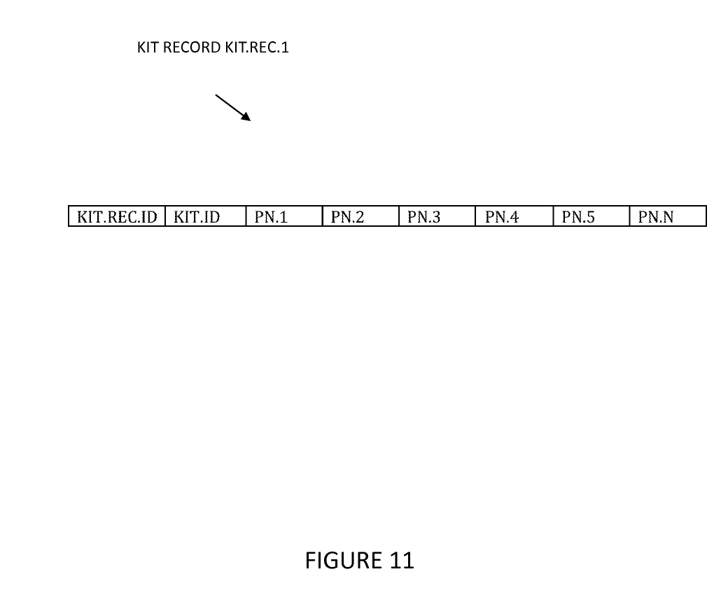

Referring now generally to the Figures and particularly to FIG. 11, FIG. 11 is a representation of an exemplary kit record KIT.REC.1 that includes a KIT record identifier KIT.REC.ID and a plurality a part number references PN.1-PN.N that each specify a part number and quantity for items that are thereby specified to be included in the instant kit.

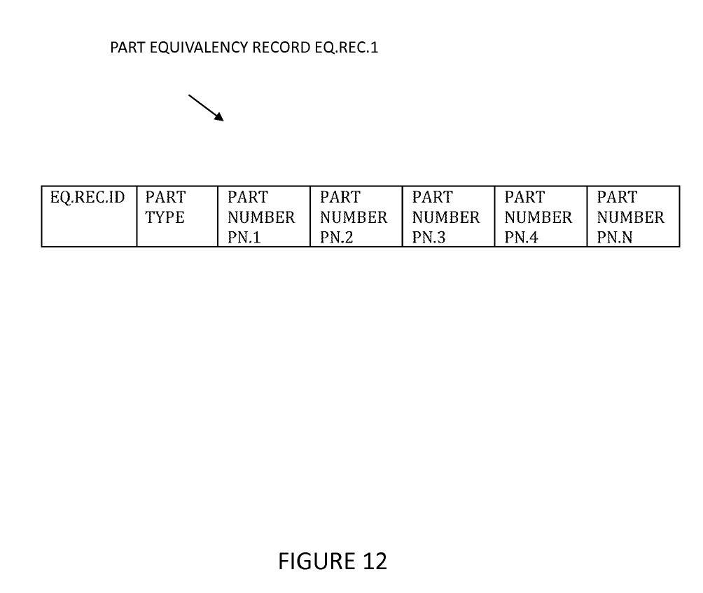

Referring now generally to the Figures and particularly to FIG. 12, FIG. 12 is a representation of an exemplary part number equivalency record EQ.REC.1 that includes an equivalency record identifier EQ.REC.ID, a part type identifier, and a plurality a part number references PN.1-PN.N that each specify a part number that is specified by inclusion in the exemplary part number equivalency record EQ.REC.1 to be equivalent with the additionally included part numbers PN.1-PN.N.

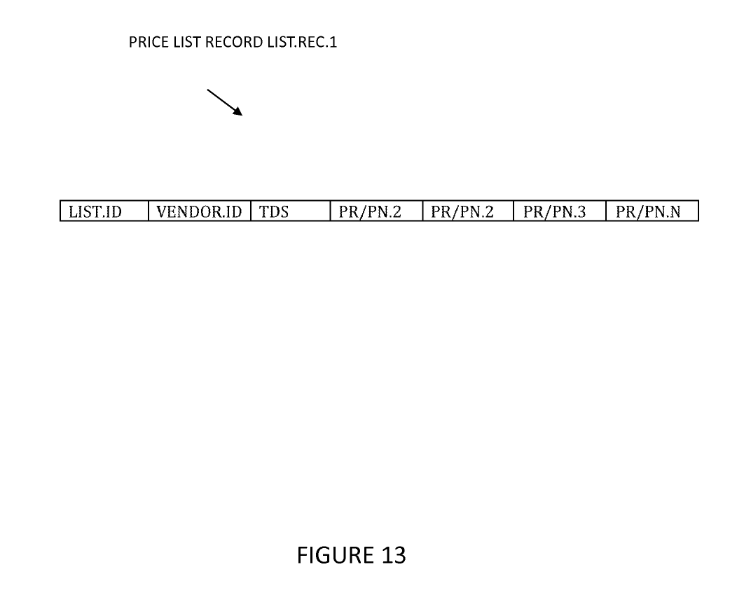

Referring now to FIG. 13, FIG. 13 is a representation of an exemplary first price record LIST.REC.1 that includes a price list record identifier LIST.ID that uniquely identifies the instant price list LIST.REC.1 within the first database DBS. Each price list record LIST.REC.1-LIST.REC.N further includes a vendor identifier VENDOR.ID of a commercial supplier or “vendor”, that sold or offered for sale the part numbers PN.1-PN.N identified within the instant price list recorded LIST.REC.1. Each price list record LIST.REC.1 further comprises a time date stamp TDS, and a plurality of price-part number pairings PR/PN.1-PR/PN.N. Each price/part number pairing PR/PN.1-PR/PN.N specifies a price at which a part number identified in the same price/part number PR/PN.1-PR/PN.N was sold or offered for sale by the vendor identified by the vendor identifier VENDOR.ID.

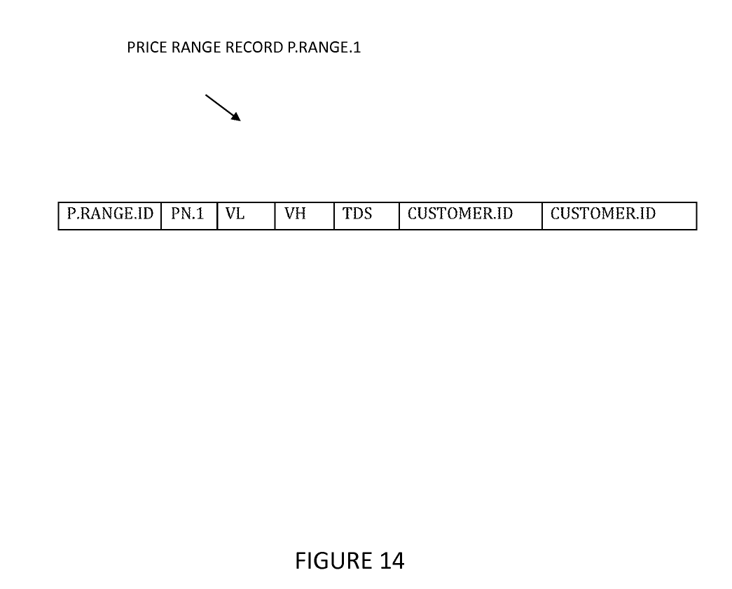

Referring now to FIG. 14, FIG. 14 is a representation of an exemplary first price range record P.RANGE.1 that includes a price range record identifier P.RANGE.ID, a first part number PN.1, a low unit price value VL and a high unit price value VH. A time date stamp TDS indicates the most recent time that the price values VL & VH were generated, or alternatively or optionally, the most recent time that the price values VL & VH reconfirmed. One or more customer identifiers CUSTOMER.ID may further be included in a price range record in order to associate a specified customer or customers with the part number PN.1-PN.N and price values VH & VL of the comprising price range record P.RANGE.1-P.RANGE.N.

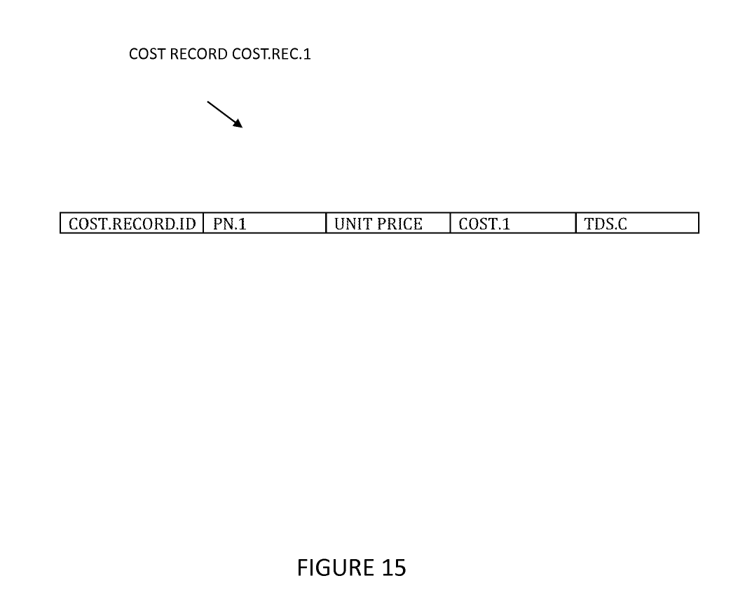

Referring now to FIG. 15, FIG. 15 is an exemplary cost record COST.REC.1 that includes a cost record identifier COST.RECORD.ID, a part number PN.1, a unit price, a part cost COST.1, and a costing time date marker TDS.C.

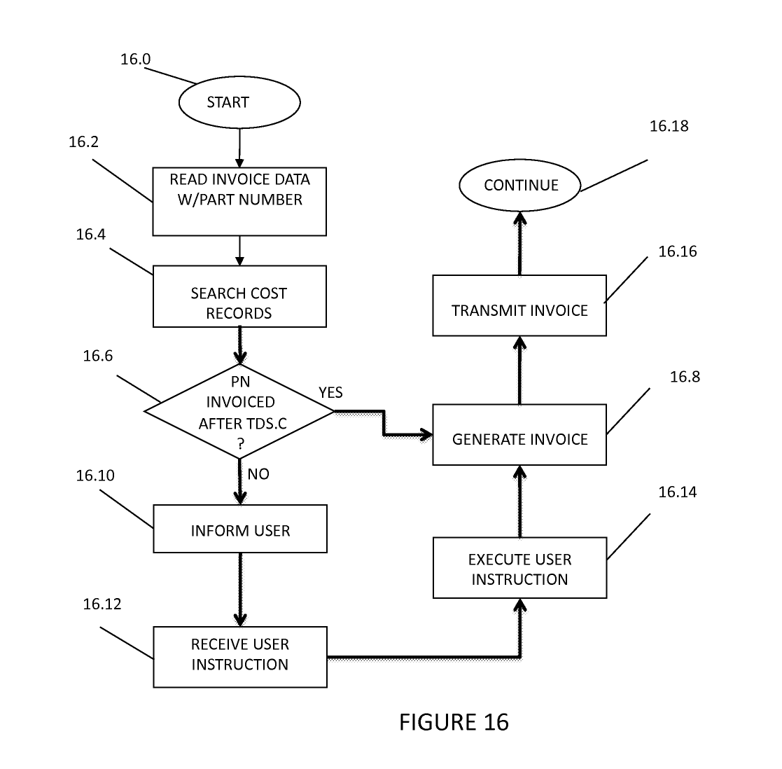

Referring now generally to the Figures and particularly to FIG. 16, FIG. 16 illustrates a first process of the invoicing system 6 wherein the invoicing system 6 reviews invoicing data prior to issuing an invoice (16.2). A plurality of accepted or generated invoicing data includes a customer identifier CUSTOMER.ID, one or more part numbers PN.1-PN.N with associated quantities, and unit prices for each part number PN.1-PN.N. In step 16.4 the invoicing system 6 searches the cost records COST.REC.1-COST.REC.N for cost time date markers TDS.0 related to each part number PN.1-PN.2.

The invoicing system 6 searches one or more databases DBS.1-DBS.N in step 16.6 and determines if each of the part numbers PN.1-PN.N read in step 16.2 has been listed in at least one invoice that was issued after the date and time specified by each cost time date marker TDS.0 associated with an instant part number PN.1-PN.N. One purpose of this query is to insure that any part number PN.1-PN.N which has had a cost increase, or other cost change, noted in a COST.REC.1-COST.REC.N is being priced as intended or desired by the issuing party. For example, when an acquisition cost of the exemplary first part number PN.1 has increased, and this costing increase is recorded in an exemplary first cost record COST.REC.1 and marked with a time and date data in the cost time date marker TDS.C, the method of FIG. 16 will inform a user if an invoice is being prepared listing the first part number at an earlier price level.

When the invoicing system 6 determines in step 16.6 that an invoice has previously been issued for each part number at some time after the individual, associated cost time date stamp TDS.0 of each part number PN.1-PN.N of step 16.2, the invoicing system proceeds on to step 16.8 and initiates an invoice record INV.REC.1-INV.REC.N

When the invoicing system 6 determines in step 16.6 that at least one part number PN.1-PN.N of step 16.2 has not been listed on an invoice since the time and date reference of a cost record time date stamp TDS.0 that references that part number PN.1-PN.N, the invoicing system notifies a user of this finding in step 16.20.

Referring now to step 16.12, the invoicing system 6 receives a user instruction from either the client system 4, the invoicing system 6, or via the Internet 12 in step 16.14 and executes the user instruction. The user instruction may direct the invoicing system 6 to (a.) halt processing or generating an invoice from the electronic invoice record; (b.) modify a unit price; or (c.) generate an invoice that does not include a part number PN.1-PN.N as specified by the user.

The invoice record INV.REC.1-INV.REC.N may alternatively or additionally be generated as an electronic invoice INV.1-INV.N and/or as a hard copy rendered from an invoice record INV.REC.1-INV.REC.N or an electronic invoice INV.1-INV.N and printed out in step 16.18. The electronic invoice INV.1-INV.N generated in step 16.8 is transmitted to the client system 6 in step 16.16 by electronic transmission via the Internet 12, by facsimile transmission via a telephony network to the purchasing system and/or by mailing of a hard copy invoice, with assistance by the user, to a customer address designated by the client system 4. The invoicing system 6 returns to alternate computational operations in step 16.18.

The foregoing disclosures and statements are illustrative only of the present invention, and are not intended to limit or define the scope of the present invention. The above description is intended to be illustrative, and not restrictive. Although the examples given include many specificities, they are intended as illustrative of only certain possible applications of the present invention. Various modifications to the disclosed aspects and embodiments of method of the present invention will be readily apparent to those skilled in the art, and the generic principles defined herein may be applied to other embodiments without departing from the spirit or scope of the teachings herein. The examples given should only be interpreted as illustrations of some of the applications of the present invention, and the full scope of the Present Invention should be determined by the appended claims and their legal equivalents. Those skilled in the art will appreciate that various adaptations and modifications of the just-described applications can be configured without departing from the scope and spirit of the present invention. Therefore, it is to be understood that the present invention may be practiced other than as specifically described herein. The scope of the present invention as disclosed and claimed should, therefore, be determined with reference to the knowledge of one skilled in the art and in light of the disclosures presented above.

What is claimed is:

1. In an information technology system, a method for processing anomalies in invoicing, the method comprising:
a. deriving a price range associated with a part number;
b. generating an invoice citing the part number and a unit sales price;
c. determining that the unit sales price is outside of the price range;
d. reporting the determination of the unit sales price being outside of the price range to a user;
e. receiving an instruction from the user regarding the invoice; and
f. executing the user instruction.

2. The method of claim 1, wherein the price range is derived from data generated within a set time period.

3. The method of claim 1, wherein the price range is derived from a history of previously issued invoices.

4. The method of claim 1, wherein the invoice is associated with a customer and the price range is derived from a history of previously issued invoices associated with the customer.

5. The method of claim 1, wherein the price range is derived from a history of prices offered for the part number.

6. The method of claim 5, wherein the history of prices offered is at least partly harvested from the Internet communications.

7. The method of claim 1, wherein the price range is derived from a history of executed sales transactions of sales of the part number.

8. The method of claim 7, wherein the history of executed sales transactions is at least partly harvested from Internet transactions.

9. The method of claim 1, wherein the user instruction directs the information technology system to archive and to not issue the invoice.

10. The method of claim 1, wherein the user instruction directs the information technology system to issue the invoice.

11. The method of claim 10, wherein the user instruction directs the information technology system to transmit the invoice via the Internet.

12. The method of claim 10, wherein the user instruction directs the information technology system to transmit the invoice via an electronic facsimile transmission.

13. The method of claim 10, wherein the user instruction directs the information technology system to transmit the invoice via a postal service.

14. The method of claim 10, wherein the user instruction directs the information technology system to modify the unit price and issue the invoice.

15. The method of claim 14, wherein the user instruction directs the information technology system to transmit the invoice via the Internet.

16. The method of claim 14, wherein the user instruction directs the information technology system to transmit the invoice via an electronic facsimile transmission.

17. The method of claim 14, wherein the user instruction directs the information technology system to transmit the invoice via a postal service.

18. An information technology system that is configured to detect and process anomalies in invoicing, the system comprising:
a. a computer accessible storage medium that is configured to store information for deriving a plurality of price ranges, each price range associated with a unique part number; and
b. a processor circuitry that is communication with the computer accessible storage medium, wherein the processor circuitry is configured:
i. to generate an invoice citing the part number and a unit sales price;
ii. determine if the unit sales price is outside of an associated price range;
iii. report a deviation of the unit sales price from the associated price range to a user;
iv. receive an instruction from the user regarding the invoice; and
v. execute the user instruction.

19. The system of claim 18, wherein the associated price range is derived from data generated within a set time period.

20. The system of claim 18, wherein the associated price range is derived from a history of previously issued invoices.

21. The system of claim 18, wherein the invoice is associated with a customer and the associated price range is derived from a history of previously issued invoices associated with the customer.

22. The system of claim 18, wherein the associated price range is derived from a history of prices offered for the part number.

23. The system of claim 18, wherein the associated price range is derived from a history of executed sales transactions of sales of the part number.

24. A computer-implemented method of processing a pricing anomaly, the method comprising:
a. forming a database of issued invoices, each invoice specifying at least one unit price associated with at least one part number;
b. generating an electronic invoice record, the electronic invoice record specifying a first one unit price associated with a first part number;
c. selecting past instances of unit prices associated with the first part number from the database of issued invoices;
d. deriving a conforming range of unit prices from the past instances of unit prices for the first part number;
e. determining that the first unit price is outside of the conforming range of unit prices;
f. reporting the determination of the first unit price being outside of the conforming range of unit prices to a user;
g. receiving an instruction from the user to issue a first invoice; and
h. issuing the first invoice as derived from the electronic invoice record.

25. The method claim 24, further comprising:
i. specifying a second unit price associated with a second part number within the electronic invoice record;
j. receiving a user instruction to delete an inclusion of the first part number from at least one line item of the first invoice; and
k. issuing the first invoice with a second line item billing specifying the second part number, whereby the at least one line item specifying the first part number is deleted from the first invoice.

26. The method of claim 24, wherein the conforming range of unit prices is derived from a list pricing generated by a third party.

27. The method of claim 24, further comprising:
i. accepting a plurality of part numbers for inclusion within the electronic invoice record;
j. determining that the plurality of part numbers are comprised within a same kit; and
k. informing the user that a kit purchase is indicated.

28. The method of claim 24, further comprising:
l. determining that a third part number associated with the kit is absent from the plurality of numbers; and
m. informing the user of the third part number and a designation of the kit.

29. The method of claim 28, further comprising:
l. determining that a fourth part number identified as similar in function to the third part number is included in the electronic invoice record; and
m. informing the user of the fourth part number; and
n. indicating to the user that the inclusion of the fourth part number may be erroneous.
